(19) United States
(12) Patent Application Publication
(10) Pub. No.: US 2002/0178138 A1
(43) Pub. Date: Nov. 28, 2002

(54) Synergistic directory-based information management system and method of using

(75) Inventors: William Ender, Phoenix, AZ (US); Jonathan Michael Gillies, Chandler, AZ (US); Joel Gillies, Phoenix, AZ (US); Joseph Gasowski, Scottsdale, AZ (US); Andrew John McCartan, Scottsdale, AZ (US); David John Thornewill von Essen, Tempe, AZ (US)

Correspondence Address: Robert D. Atkins, Semiconductor Components Industries, LLC, Patent Administration Dept - MD A230, P.O. Box 62890, Phoenix, AZ, 85082-2890, US

(73) Assignee: Semiconductor Components Industries, LLC

(21) Appl. No.: 09/805,969

(22) Filed: Mar. 15, 2001

(51) Int. Cl. G06F 7/00

(52) U.S. Cl. 707/1

(57) ABSTRACT

Centralized, directory services (20) are provided to maintain employee information accessed by systems of record (12,14,16 and 18). An automated information management system (10) utilizes directory services (20) to synchronize employee data with systems of record (12, 14, 16 and 18), substantially reducing the manual labor associated with data synchronization. An additional feature of information management system (10) provides an automatic process for employee services generation (FIG. 4) and employee service charge verification (FIG. 3). A wireless communication system (100) to directory services (20) allows access to directory (46) from a two-way paging device via.

### BACKGROUND OF THE INVENTION

The present invention relates in general to directory services and, more particularly, to directory services that provide automated error checking and information update services to produce a synergistic information management system.

Most corporations and larger companies operating with a substantial number of employees typically employ data management systems. The employee data management systems contain data stores, or directories, which contain employee specific data. Many such data stores, or directories, exist within the data management system to support several departments within the corporation or company. Human resource departments, for example, require all of the information for each employee to be stored in the directories for such support services as payroll, benefits, etc. In addition, other departments, such as finance departments, require much of the same information already contained in the human resource directory. In general, separate directories are maintained by the finance department, for example, to maintain employee specific information that is germane to the financial function of the corporation or company. The resultant information system of the corporation or company is a network of isolated, stand-alone data systems, each with their own method and protocol for access.

As employee specific information changes, such as home address, home phone number or pay scale, for example, each of the stand-alone data systems must individually be updated with the correct information. The information update for the employee usually requires a substantial effort involving manual updates of the stand-alone data systems, across multiple departments usually involving several man-hours of labor, spanning several days or even weeks. Simple information updates, therefore, can require an inordinate amount of individual effort. In addition, considering the amount of individual effort required, typographical errors have a high probability of occurrence, which can lead to erroneous information being stored for a particular employee that is not consistent across all of the individual directories. Industry statistics show that a majority of the information data systems for large companies are manually updated and manually synchronized requiring a tremendous labor effort to maintain current employee information.

Hence, there is a need for a synergistic information management system which provides access to a directory service allowing manipulation and synchronization of data contained within the information management system.

### BRIEF DESCRIPTION OF THE DRAWINGS

FIG. 1 is a block diagram illustrating a synergistic information management system;

FIG. 2 is a block diagram of the directory services block shown in FIG. 1;

FIG. 3 is a flow diagram of third party billing validation;

FIG. 4 illustrates a new employee update flow diagram;

FIG. 5 illustrates a wireless access diagram to the directory services block shown in FIG. 2; and

FIG. 6 illustrates a typical pager design form.

### DETAILED DESCRIPTION OF THE DRAWINGS

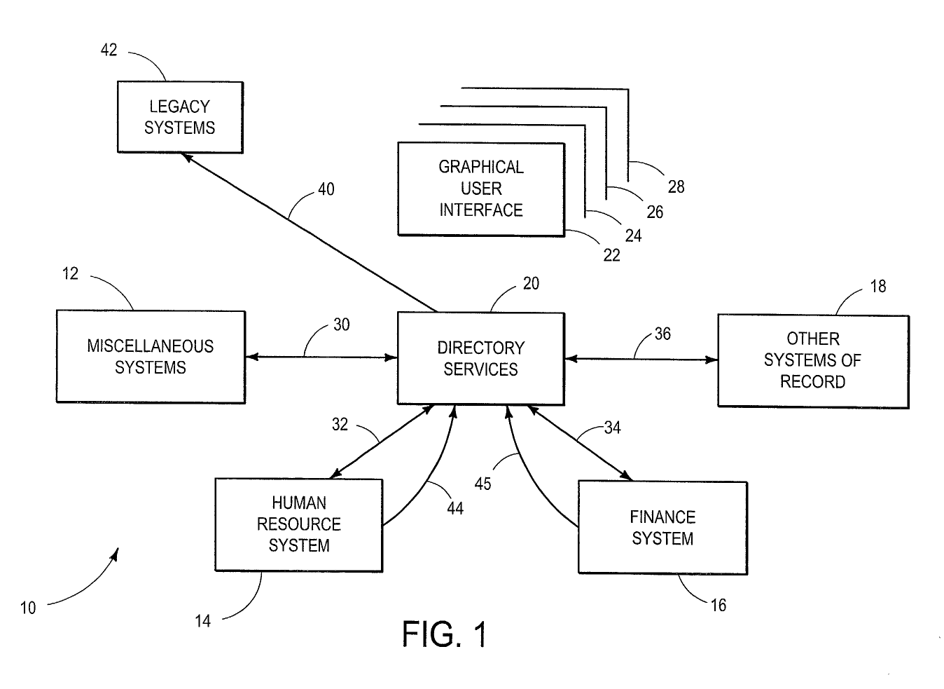

In FIG. 1, a synergistic information management system 10 is illustrated. Graphical User Interface (GUI) 22 provides the input/output mechanism for users of information management system 10 (not shown) interacting with directory services 20. Multiple instantiations of GUI 22 can be invoked for multiple users as illustrated by instances 22, 24, 26 and 28. GUI's 22, 24, 26, and 28 are shown to be active, indicating simultaneous multiple user activity. It is understood that many more instantiations of GUI 22 may be invoked, depending on user load. Subsequent references to GUI 22 hereinafter implies the possibility of multiple instantiations of GUI 22. Systems of Record (SOR) 12, 14, 16 and 18 are shown to have two-way communication with directory services 20 as indicated by double arrows 30, 32, 34 and 36, respectively. SOR's, illustrated in FIG. 1, include Human Resource System 14, Finance System 16 and Miscellaneous Systems 12, for example, but other SOR's may exist as depicted by Other SOR's 18. Information management system 10 provides support to legacy systems 42, which can not communicate with directory services 20 in the manner implied by two-way communication channels 30-36. Communication channel 40, for example, utilizes File Transfer Protocol (FTP) for data transmission to legacy systems 42. Directory services 20 provides data updates to text based files existing within a file repository, through the use of FTP. Legacy systems that do not have communication capability with directory services 20, as characterized by data channels 30-36, may still obtain information provided by directory services 20, through access to the text files stored in the file repository.

GUI 22, as discussed earlier, provides the information input/output mechanism, which facilitates user interaction with information management system 10. GUI 22 is typically available to all users through the use of a computer terminal (not shown). The computer terminals are commonly connected via an intra-network, or intranet, (not shown), which supplies networked applications to all users having access to the intranet. Directory services 20 provides, among other features, a central directory 46, containing all pertinent data associated with a database object, an employee object for example, which is common to SOR's 12-18. GUI 22 allows users of information management system 10 to access data contained within directory services 20. Providing directory 46 enables SOR's to independently access directory 46 for information germane to the particular SOR. Once GUI 22 has been launched at a user's workstation, the user is enabled to utilize services provided by directory service 22, given successful authentication of the user.

A first service provided by GUI 22 is that of a search engine. Users of the search engine have the option of utilizing a basic search or an advanced search to locate and retrieve information related to a specific data object. The basic search query requires a single field of identifying information to be entered in order to locate the data record associated with the object of interest within directory services 20. The single field of information is, for example, name or employee number, associated with the employee of interest. Once the single field of identifying information has been submitted to directory services 20, directory 46 is searched to find information correlating to the single field of identifying information. Given that the data record correlating to the single field of identifying information has been located, detailed information concerning the employee of interest contained within the data record is formatted and presented to the user by GUI 22, provided the user has sufficient security access privileges to the employee information.

The advanced search engine operates in substantially the same manner as the basic search engine, however, the advanced search engine allows multiple fields of identifying data, or search objects, to be entered by the user, which is subsequently used by the advanced search engine to locate the data record of the employee or object of interest. In addition to the multiple search objects accepted by the advanced search engine, a search object condition is also accepted. The search object condition allows the Boolean operator “AND” or “OR” to be used in conjunction with the search objects to formulate the search criteria. The search objects, for example, are selected from the following data element groups: “Name”, “Department”, “Email ID” or “Maildrop” to name only a few. The search object condition, for example, can be employed to locate all users with the following search criteria: Dept.=“Department” OR MD=“Maildrop”. All users whose department number is equivalent to “Department” or whose maildrop number is equivalent to “Maildrop” are located and information concerning those employees or objects subsequently displayed to the user by GUI 22.

A second service offered by directory services 20 is a reporting function. Users of directory services 20 request customized reports containing formatted information contained within directory services 20. The number of customized reports that are possible from directory services 20 are boundless and are designed to the specific requirements of the user. Examples of customized reports include listings of all locations worldwide of the company of interest, or perhaps a complete listing of all employees currently contained within the database. Once the customized reports are designed and requested by a user, the customized reports are generated and stored within a customized report repository, visible to the specific user only.

A third service offered by directory services 20 is an updating function. An updating function is required in order to maintain the database with current information. Personal data such as home address, last name or work location are examples of data objects requiring modification at regular intervals. Appropriate authentication and authorization is provided by directory services 20, so that only authorized personnel are allowed to modify employee information. Varying levels of access rights are given to users of information management system 10 according to the access privileges of the specific user. Access roles are given to employees, administrative personnel and security personnel, for example, to define the levels of access. Security personnel, for example, are given access to security information, but are not, for example, given access rights to payroll information.

In addition to containing employee specific information within directory services 20, other information is maintained including, but not limited to, contractor and customer profiles. All information relating to external personnel doing business with the company or corporation is tracked and maintained in a concise, accurate and centralized location.

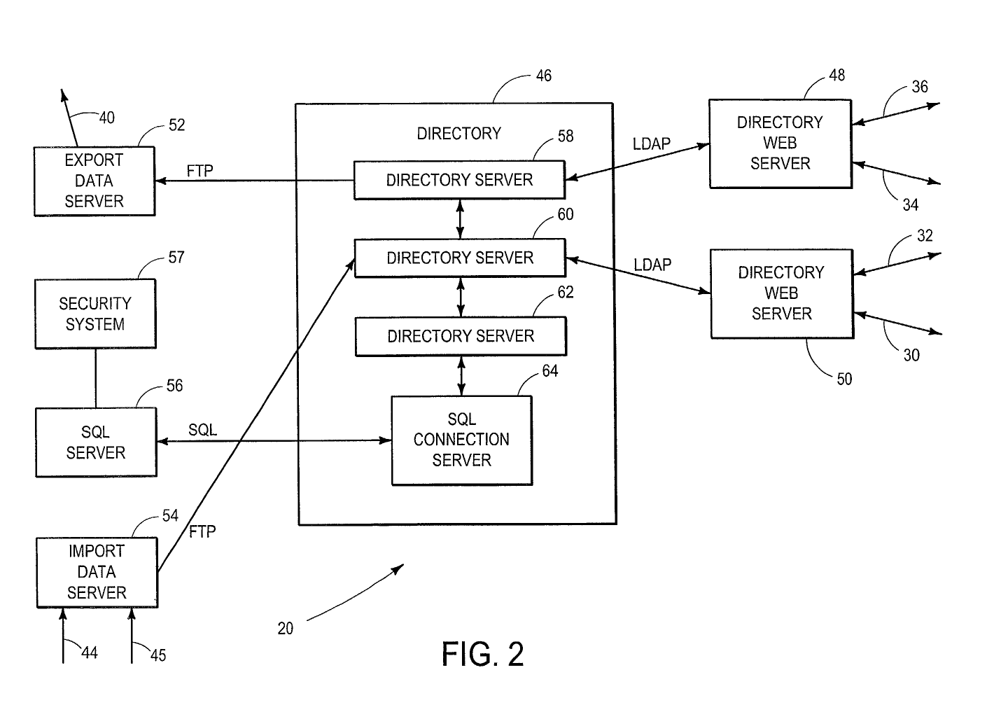

FIG. 2 illustrates a block diagram of directory services 20. Directory web servers 48 and 50 provide access to information contained in directory 46 through a common browser based interface implemented by GUI 22. Directory web servers 48 and 50 comprise the web site, which is accessible via GUI 22. Directory web servers 48 and 50 use Lightweight Directory Access Protocol (LDAP) to connect to directory servers 58-62 for user authentication, search and maintenance. Communication channels 30-36 provide the data path necessary to provide the user with access to directory information via GUI 22, as discussed earlier.

Directory servers 58, 60 and 62 provide the directory service which is a core function of information management system 10. Directory servers 58, 60 and 62 execute a directory service software package such as the Novell Directory Service eDirectory, as produced by Novell Corporation. The operating system running on directory servers 58, 60 and 62, for example, is NetWare, also produced by Novell Corporation. Directory servers 58, 60 and 62 are duplicated for redundancy and provide a platform, which supports dynamic replication of data across servers 58-62 as well as provide support of the LDAP communication protocol standard.

The communication model adopted by the LDAP communication protocol is one of clients, web servers 48 and 50, performing LDAP protocol operations against directory servers 58-62. The LDAP clients, web servers 48 and 50, transmit a protocol request describing the operation to be performed by directory servers 58-62. Directory servers 58-62 are then responsible for performing the necessary operations in directory 46. Upon completion of the operations, directory servers 58-62 return a response containing any results or errors to requesting clients, web servers 48 and 50. Table 1 lists a representation of LDAP messages transmitted by directory web servers 48 and 50 to directory servers 58-62.

TABLE 1
Request (LDAPMessage)
bindRequest
searchRequest
modifyRequest
addRequest
delRequest
compareRequest

LDAP message “bindRequest” allows authentication information to be exchanged between web servers 48 and 50 and directory servers 58-62. If authentication fails, the bind request is not honored by directory servers 58-62, thus terminating the directory access session. LDAP message “searchRequest” allows web servers 48 and 50 to request directory servers 58-62 to conduct a search on directory 46, whereupon a successful search produces a result, returned by directory servers 58-62, in an LDAP Search Response message. LDAP message “modifyRequest” allows web servers 48 and 50 to modify the value of object entries contained within directory 46. The result of the modify request is in an LDAP Modify Response message. LDAP messages “addRequest” and “delrequest” allow web servers 48 and 50 to add or delete objects, respectively, within directory 46 through directory servers 58-62. Responses to add and delete requests are made through LDAP response messages Add Response and Delete Response, respectively. LDAP message “compareRequest” allows web servers 48 and 50 to compare an assertion provided with an entry in directory 46. An LDAP response message Compare Response is subsequently provided by directory servers 58-62, giving the results of the compare operation. It can be seen, therefore, that a substantial portion of directory operations required by web servers 48 and 50 can be executed by the LDAP message set contained within Table 1.

Security system 57 contains a database of all employees and contractors contained within directory 46. The employees and contractors each have a unique identification number and associated security badge, which is used to facilitate ingress and egress of the workplace. A proximity card reader is used to read identification information about the employee or contractor in possession of the security badge for both egress and ingress operations. The database contained within security system 57, therefore, must be synchronized to object information contained within directory 46, in order to properly function. Security system 57, therefore, receives updates from directory 46 via Structured Query Language (SQL) connection server 64 and SQL server 56. A logging application, LOG, running on directory servers 58-62 monitors activity within directory 46 for changes to employee or contractor data initiated by SOR's connected to directory 46. Once a change to employee or contractor data is detected, such as employee termination, the specific change is scrutinized by the logging application to determine if the change affects security system 57. Since employee termination is important to security system 57 for ingress and egress procedures, the logging application reports an employee termination, which initiates a data synchronization process to occur between directory 46 and security system 57, via SQL server 56 and SQL connection server 64. Once the employee termination data is synchronized, terminated ingress is no longer allowed and security integrity is maintained.

An event monitor running on directory servers 58-62 coordinates with logging application, LOG, to provide a log of object changes within directory 46. The event monitor traps change events to directory 46 such as adding objects, deleting objects or updating object attributes within directory 46. LOG receives the events trapped by the event monitor and performs a filtering function. The filtering function scans the event for events of interest. Once an event of interest is found, LOG generates an update for the object that is changed within directory 46 and reports the update to SQL server 56 via SQL connection server 64. The updates occur at periodic rates of 2 minutes, for example, such that security system 57 receives directory object updates every 2 minutes. In other words, an event driven updating system is employed through the use of LOG, directory servers 58-62, SQL connection server 64 and SQL server 56 to maintain synchronization of data residing within security system 57. The rate at which updates occur is programmable and is set by logging application LOG.

Export data server 52 provides a repository for exported data from directory 46. Directory 46 utilizes the known PUT function resident within the FTP communication protocol to update text files resident on export data server 52. The FTP PUT procedure is executed on a repeating schedule, for example, during daily backup execution runs. Conversely, import data server 54 provides a repository for update information transmitted from, for example, human resource system 14 and finance system 16. The known FTP PUT procedure is followed by human resource system 14 and finance system 16 to place update data onto import server 54, for subsequent access by directory server 60 using the known FTP GET procedure.

As discussed earlier, two-way communication channels 30, 32, 34 and 36 are required to allow users within SOR's 12-18 to manipulate data contained within directory 46. An example of a powerful utility of information service 10 is the process whereby new employees are added into directory 46. Users operating from human resource system 14, for example, are required to enter information about the new employee. A data session is instantiated between a user at human resource system 14 and directory web server 50, utilizing communication channel 32. The user enters <userid> and <password> information to establish the data session with directory web server 50. Directory web server 50 authenticates the user at human resource system 14, via an LDAP bind request, prior to data entry into directory 46. Critical data fields such as name and department number are entered by the user in human resource system 14 to create a new employee data record within directory 46. Directory servers 58 and 62 are subsequently updated by directory server 60 with the new employee information, to maintain the proper redundancy for data protection. Import data server 54 receives a comprehensive data update by human resource system 14, via an FTP PUT procedure, during the daily scheduled script execution the FTP PUT procedure. The comprehensive data update comprises, for example, new employee data such as phone number, pager number and location code. In other words, once the initial data record is created by the user at human resource system 14 during the web session, a comprehensive data update follows, whereby all known information concerning the new employee is updated via import data server and communication channel 44.

An FTP user account is setup on import data server 54 which is unique to the system, or SOR, that is using it. An FTP user account, for example, is established to facilitate the FTP PUT procedure from human resource system 14 to import data server 54. The FTP account is assigned an owner, a password and a home directory. The user is then responsible for setting up the FTP PUT process, which is a known process whereby a user at human resource system 14, for example, provides data to import data server 54, via FTP.

A typical FTP transfer script file, SCRIPT1.TXT, may contain the following information:

<userid>

<password>

PUT EMPLOYEE.TXT

where <userid> and <password> are required information elements to establish communication channel 44 between human resource system 14 and import data server 54. “EMPLOYEE.TXT” contains comprehensive employee update information, as discussed above, used by human resource system 14 to populate the new employee data record within directory 46. A typical batch file is then created which is executed daily by, for example, a scheduler running on human resource system 14. The batch file may contain the following command:<ftp -s:SCRIPT1.TXT SERVER>. Once the batch file is executed, an FTP session is spawned by the “ftp” command contained within the batch file, which creates an FTP link between human resource system 14 and import data server 54. “SERVER” is the Internet Protocol (IP) address of import data server 54. The contents of script file “SCRIPT1.TXT” are then used to authenticate the FTP session with <userid> and <password>. Once the PUT operation has been completed, an FTP GET operation is initiated by import data server 54, to receive comprehensive employee information file, EMPLOYEE.TEXT. Once the file is received, a data filtering process is spawned within import data server 54.

A data filtering process, known as data normalization, is a process utilized by import data server 54 to format data contained within file, EMPLOYEE.TXT for example, into an acceptable format suitable for use by directory 46. Once the data normalization process has filtered and sorted the comprehensive employee data contained within file EMPLOYEE.TXT, the data is scanned for errors. A typical error, for example, is a data field associated with an employee which contains a typographical error. The error might exist, for example, within the department number field of the employee data record. The erroneous department number is accepted by an error detection process, or script, and compared with a list of official department numbers currently on record within directory 46. Upon detection of the erroneous department number, an error report, ERROR.TXT, also known as a difference report, is generated by the error detection script, delineating the specific error found by the error detection script. Once the error, or difference, report is generated by import data server 54, the error, or difference, report is transmitted via email, for example, to human resource system 14. Directory service 22 transmits data file ERROR.TXT, for example, to clearly describe data errors potentially found within file EMPLOYEE.TXT, previously transmitted by human resource system 14. Once ERROR.TXT is received by human resource system 14, appropriate personnel are alerted as to the erroneous information and the erroneous information is subsequently corrected. The correct information is then updated within directory 46 during the next FTP PUT session of EMPLOYEE.TXT to import data server 54.

Table 2 represents an example of properly formatted data contained within file EMPLOYEE.TXT for use by directory 46. Information fields for each record are delineated with a TAB character and each new line represents a new record.

TABLE 2

| RECORD | DESCRIPTION |
|---|---|
| Commerce ID | Global employee unique |
| | identifier |
| First Name | Employee first name |
| Last Name | Employee last name |
| Department | Employee department number |
| Pager | Employee pager ID number |

It should be noted that the size of file EMPLOYEE.TXT is as large as is required by human resource system 14 to fully characterize a given employee and is not limited to the information provided in Table 2. In the event that EMPLOYEE.TXT contains information that is not formatted as shown in Table 2, the data normalization process contained within import data server 54, as discussed above, reformats the data into a format suitable for use by directory 46.

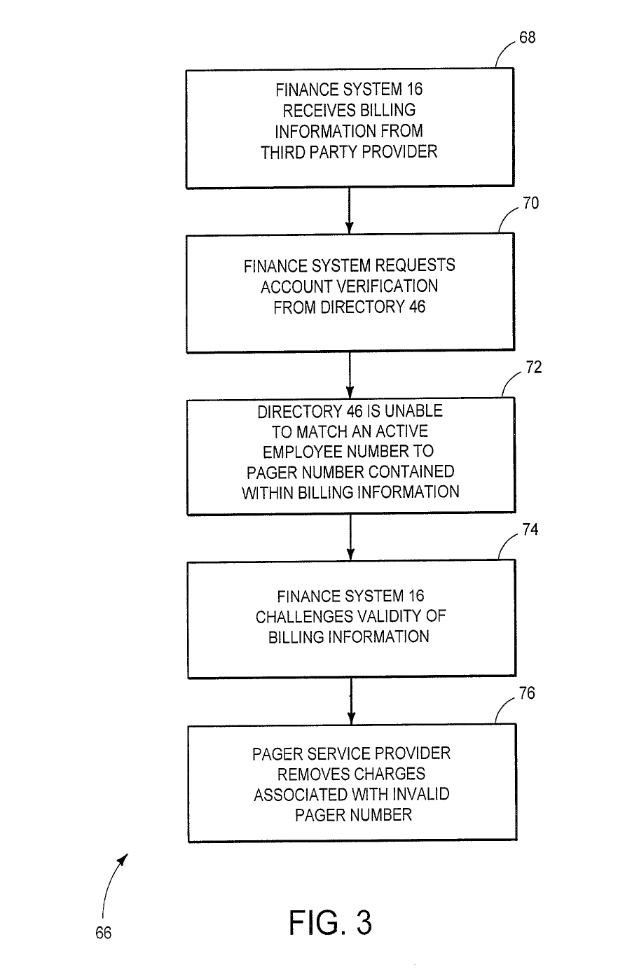

An important feature of information management system 10 is asset management. Asset management can be monitored by information management system 10 because many of the assets such as pagers, cellular telephones and computers are associated with a particular employee or contractor of the company and are easily managed by directory services 20. Assets, such as pagers, incur monthly service charges from the paging service provider. Larger companies may have tens of thousands of employees, each accruing monthly service charges from the paging service provider. Information management system 10 provides a manageable system, which facilitates detection of inaccurate billing information from the paging service provider, as illustrated by flow diagram 46 of FIG. 3. Data flow 68 provides billing information from a third party service provider such as a paging service provider, for example, to finance system 16. A standard function provided by finance system 16 is to validate all charges received from third party service providers. Data flow 70 provides an account verification for all accounts itemized within the billing information provided by the paging service provider. Account verification is requested via an FTP PUT process, as discussed earlier, whereby a data file containing commerce ID numbers and associated pager numbers is transmitted to import data server 54, via communication channel 45. The valid commerce ID numbers and associated pager numbers contained within the data file correlate with billing information as provided by the pager service provider.

Each data record contained within the data file is formatted and scanned for erroneous information, as discussed earlier. Data flow 72 provides the error mechanism within directory 20 used to detect erroneous billing information. Directory 20 is unable to correlate a pager number contained within the billing information provided by the pager service provider to any active employee's commerce ID number contained within directory 20. An error report, or difference report, is then generated in response to the lack of correlation between any employee's commerce ID number and the pager number and reported to finance system 16 via email, for example. Data flow 74 provides a challenge initiated by finance system 16, in response to the difference report generated by directory 20, to the validity of billing information provided by the pager service provider. Data flow 76 provides the removal of erroneous charges by the pager service provider in response to the error report generated by directory 20. Directory 20, therefore, facilitates a reduction in operating costs by eliminating erroneous charges for services rendered to non-existent employees.

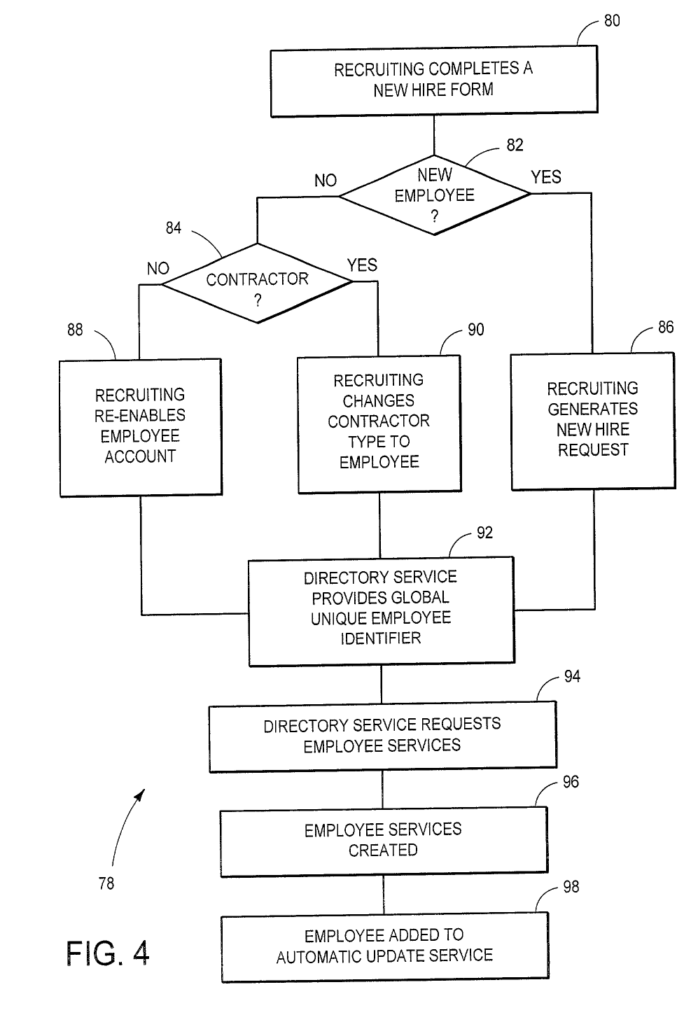

An additional advantage of information management system 10 is the automated employee services creation mechanism, as illustrated in FIG. 4. FIG. 4 illustrates a typical flow diagram 78 depicting the process for hiring a new employee. Data flow 80 provides the completion of a new hire form by the recruiting department, which is typically contained within human resource system 14. If the employee is a new employee 82, the recruiting department generates a new hire request 86. If the employee was a previous employee, data flow 84 queries as to whether the employee was a contractor. Data flow 90 changes the account type from “contractor” to “employee”, provided the employee was formerly a contract employee. If the employee was not a contractor, but was a previous employee, recruiting re-enables the employee account 88. Data flows 86, 88 and 90 all lead to data flow 92, which illustrates directory services 20 as generating a unique, global employee identification number, or commerce ID number. Data flow 94 provides a unique operation of information management system 10, in which employee services such as email accounts, calendar accounts, security accounts etc. are automatically requested upon the generation of the commerce ID number. FTP or email requests are delivered to the appropriate service providing entities in data flow 94, requesting any and all employee services to be activated. Once employee services are created in 96, the new employee is automatically added to the automatic FTP updating system discussed herein, which substantially insures employee data synchronization.

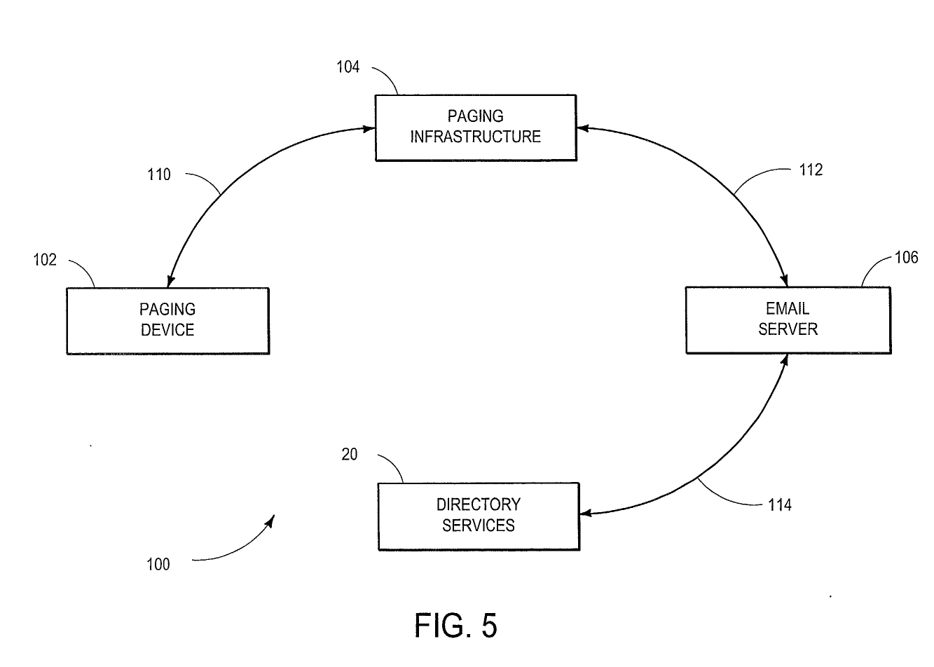

A further advantage to information system 10 is illustrated in FIG. 5. As discussed herein, access to directory 20 is facilitated by an intranet connection to directory web browsers 48 and 50 using the LDAP communication stack. An additional access to directory 20 is achieved via a wireless link. A wireless access method is illustrated by communication system 100, whereby paging device 102 communicates with paging infrastructure 104 as provided by a paging service provider, such as Skytel Corporation, for example. Paging infrastructure 104 communicates with email server 106, which communicates with directory services 20. Email server 106 is considered to be contained within Other SOR's 18. Communication links 110 and 112 utilize the known Simple Mail Transport Protocol (SMTP) for data exchange. Paging device 102 provides two-way way communications, whereby messages are transmitted to and received from paging infrastructure 104.

In order to facilitate data exchange with directory services 20, paging device 102 is equipped with electronic data request forms. Electronic data request forms are developed utilizing a scripting language using an Interactive Development Environment (IDE) running on a development workstation.

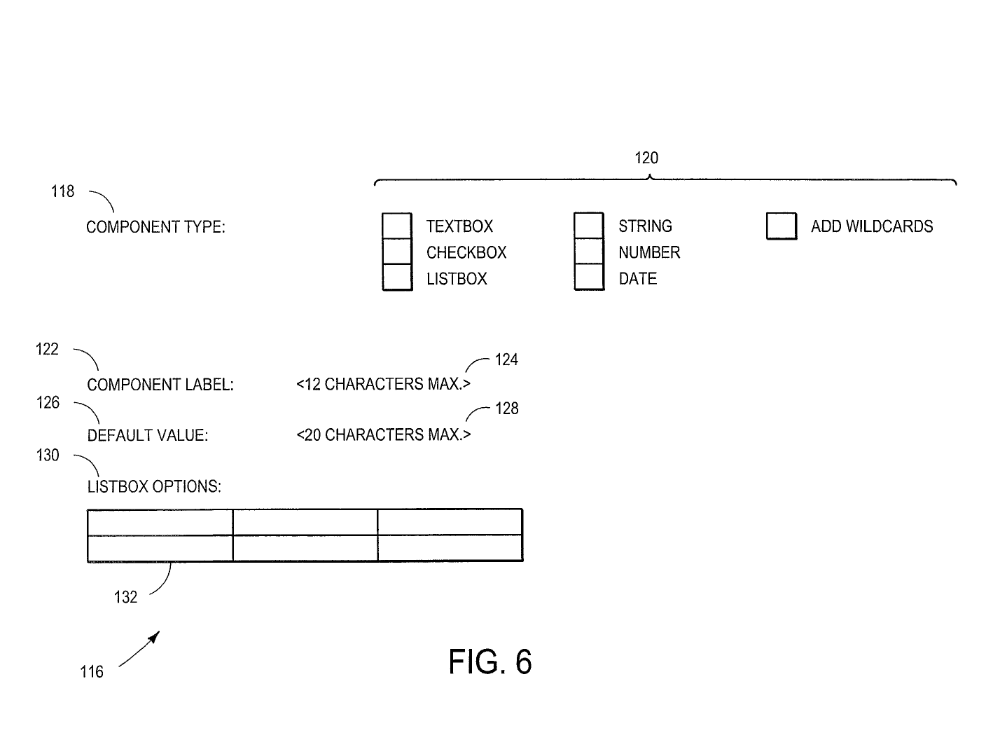

FIG. 6 displays a typical design form 116, which a software programmer uses to design the electronic data request form. Electronic data request forms may contain many data objects, each object defined by design form 116. Each data object in the electronic data request form contains a Component Type attribute label 118, having Component Type attributes as delineated by 120. The data object contains a Component Label attribute label 122, which is defined by character string 124. A default value 128 is defined for data object attribute label Default Value 126. Attribute label Listbox Options 130 provides up to six options 132, which correlate to the Listbox checkbox of Component Type attributes 120. Once completely designed, an executable version of the electronic data request form is compiled using the IDE and subsequently downloaded into paging device 102.

A user in possession of paging device 102 begins a data acquisition session with directory services 20 by displaying the electronic data request form on paging device 102. Once the electronic data request form is displayed to the user in possession of paging device 102, the user simply fills in the desired information using a keypad on paging device 102 and transmits the data request in exactly the same manner as is followed to transmit any other text message from paging device 102. Paging infrastructure 104 receives the data request from paging device 102 and forwards the data request to email server 106. Once received, the data request is processed by email server 106, converted into an LDAP request data sequence by directory web server 48 and submitted to directory server 58. Once the LDAP request is processed by directory server 58, directory server 58 responds with an LDAP response, as discussed previously. The LDAP response from directory server 58 20 is formatted by email server 106 into a format suitable for use by paging device 102. The suitably formatted email message from email server 106 is then transmitted to paging infrastructure 104, for subsequent transmission to paging device 102. It can be seen, therefore, that two access methods to directory services 20 are provided, conventional and wireless. Conventional intranet access via web based browsers and wireless access via two-way paging devices are used to proliferate data exchange between directory services 20 and users of directory services 20.

By now it should be appreciated that a synergistic information management system has been presented which substantially facilitates directory data manipulation between a centralized directory service and the SOR's coupled to the centralized directory service. Employee data is synchronized through automatic generation techniques which substantially decreases manual labor. In addition, assets such as pagers and cellular telephones are substantially managed by the centralized directory service to control service costs for the assets. An additional feature of the information management system provides for wireless access into the information management system via two-way paging devices.

What is claimed is:

1. An information management system organized to maintain an accurate representation of a list of data objects, comprising:
a system of record coupled to receive data objects;
an updating system coupled to receive the data objects from the system of record and coupled to provide the data objects organized into a first list of data objects in a first format at predetermined intervals; and
a directory coupled to receive the first list of data objects and coupled to provide a second list of data objects in a second format to the updating system at the predetermined intervals.

2. The information management system of claim 1, wherein the system of record comprises:
a graphical interface coupled to provide a data input mechanism to the system of record and coupled to provide a data output mechanism from the system of record; and
a communication interface coupled to provide two-way communication between the system of record and the updating system.

3. The information management system of claim 1, wherein the updating system comprises a file transfer mechanism coupled to transfer the first list of data objects and coupled to transfer the second list of data objects at the predetermined intervals.

4. The information management system of claim 1, wherein the directory comprises:
a first directory server coupled to receive the first list of data objects and coupled to provide the second list of data objects; and
a second directory server coupled to receive the first list of data objects from the first directory server to maintain redundant sets of the first list of data objects.

5. An information management system coupled to maintain synchronization of first data objects contained within a first storage area to second data objects contained within a second storage area, the information management system comprising:
a directory coupled to receive the first data objects and coupled to store the data objects into the first storage area;
an event system coupled to detect a first set of all changes made to the first data objects and coupled to provide a second set of changes equal to a portion of the first set of all changes; and
an update system coupled to receive the second set of changes and coupled to modify the second data objects in response to the second set of changes.

6. The information management system of claim 5, wherein the directory comprises:
a directory server coupled to receive the first data objects and coupled to provide the first data objects to the first storage area contained within the directory server; and
a connection server coupled to receive the first data objects from the first storage area and coupled to provide the second data objects to the second storage area.

7. The information management system of claim 5, wherein the event system comprises:
an event monitor coupled to receive the first set of changes made to the first data objects; and
a log application coupled to receive the first set of changes and coupled to provide the second set of changes at predetermined time intervals.

8. A method of operating an automatically updated information management system, comprising:
editing a first data object in a first device;
detecting changes made to the first data object in the first device; and
equating a second data object to the first data object upon detection of the changes made to the first data object.

9. The method of claim 8, wherein editing the first data object in the first device comprises:
authenticating a user at a data terminal; and
performing a data edit operation within the first device.

10. The method of claim 9 wherein authenticating the user at the data terminal includes authenticating the user at a wireless data terminal.

11. The method of claim 8, wherein detecting changes made to the first object comprises:
executing an event services function within the first device; and
logging events from the event services function.

12. The method of claim 11, wherein equating the second data object to the first data object comprises:
examining the logged events which affect the second data object; and
updating the second data objects affected by the logged events to equate the second data objects to the first data objects.

13. A method of using an information management system to validate an external set of information, comprising:
storing a set of internal information in a directory;
receiving a set of external information;
comparing the set of external information to the set of internal information to produce a set of difference information; and
utilizing the set of difference information to alter the set of external information.

14. The method of claim 13 wherein receiving a set of external information in a directory comprises engaging a first file transfer function at predetermined intervals to place a file of information into a repository.

15. The method of claim 14 wherein comparing the set of external information to the set of internal information comprises:
engaging a second file transfer function at the predetermined intervals to retrieve the file of information from the repository; and
comparing the file of information to the internal information to produce the difference information.

16. The method of claim 13 wherein utilizing the set of difference information to alter the set of external information comprises engaging a scrubbing function to create an error report utilized to correct errors in the external information.

17. A method of using an information management system to facilitate a new hiring process, comprising:
entering data associated with a new employee into a directory;
automatically requesting employee services from within the directory; and
adding the employee to an updating function of the information management system.

18. The method of claim 17 wherein entering data associated with the new employee comprises:
authenticating a user at a data terminal; and
performing a data edit operation within the information management system to add data objects associated with the new employee.

19. The method of claim 17 wherein automatically requesting employee services comprises requesting electronic services including,
(a) electronic mail accounts, and
(b) electronic schedulers.

20. The method of claim 17 wherein adding the employee to an updating function comprises adding the employee to an automatic file transfer mechanism, wherein the automatic file transfer mechanism synchronizes employee data between a first device and a second device.

21. The method of claim 17 wherein adding the employee to an updating function comprises:
triggering an event in response to adding the employee; and
initiating a data transfer from a first system to a second system in response to the event.
